(19) United States
(12) Patent Application Publication
(10) Pub. No.: US 2024/0051471 A1
(43) Pub. Date: Feb. 15, 2024

(54) Collapsible Vehicle Accessory Mount

(71) Applicant: Glen Heacock, Sellersburg, IN (US)

(72) Inventor: Glen Heacock, Sellersburg, IN (US)

(21) Appl. No.: 18/361,975

(22) Filed: Jul. 31, 2023

Related U.S. Application Data
(60) Provisional application No. 63/371,267, filed on Aug. 12, 2022.

(51) Int. Cl. B60R 9/06; B62B 3/00; B62B 3/02

(52) U.S. Cl. CPC B60R 9/06; B62B 3/007; B62B 3/02

(57) ABSTRACT

A vehicle accessory mounting system including a collapsible tire attachment provides a secure way for mounting accessories to an automobile, using an externally mounted tire as a mounting point. The external tire provides solid mounting surface for attaching a collapsible tire attachment without interfering with access to the trunk or the rear hatch of the vehicle, and may be installed and removed without making permanent modifications to the vehicle frame or chassis. A collapsible tire attachment includes a central bracket and a plurality of arms, each arm configured to extend beyond the radius of the automobile tire, where each of said arms may be releasably attached to the tire using tire connectors. The collapsible tire attachment may further be configured for removable attachment to an accessory mount, which may in turn support a variety of vehicle accessories, including baskets, wagons, flags, poles or banners.

### CROSS-REFERENCE TO RELATED APPLICATIONS

This application claims priority from U.S. Provisional Application No. 63/371,267 filed on Aug. 12, 2022, the full disclosure of which is hereby incorporated by reference.

### BACKGROUND

The present disclosure relates to vehicle accessory mounting systems and vehicle accessories configured to attach to the external tire of an automobile, and methods for using the same.

It has long been desirable for automobile owners, particularly owners of sport utility vehicles, recreational vehicles and jeep-style vehicles, to add rear-mounted accessories to their vehicles for purposes such as the storage and transport of coolers, containers, bicycles, and other items that the automobile owner cannot or may not want to transport in the interior of the vehicle. However, traditional methods of mounting such accessories to a vehicle have several drawbacks.

For example, some conventional methods of mounting accessories on a vehicle are configured to attach to a vehicle's trailer hitch. These methods provide a secure attachment between the vehicle and the accessory or accessory mounting system. But, because such methods utilize the trailer hitch, they cannot be used if the hitch is needed for some other purpose, or on vehicles lacking a hitch. Moreover, this style of tire mounted accessory typically blocks access to the vehicle's trunk or rear door, and must be manipulated out of the way or removed from the vehicle entirely in order to access the rear of the vehicle.

Other methods of mounting accessories onto a vehicle exist that rely on affixing the accessory or accessory mounting system on another portion of the vehicle, such as a portion of a pick-up truck's bed or frame. Depending on the location of the mount, these methods may also interfere with the operation of the trunk or rear door of the vehicle. And, these methods may require irreversible modifications to be made to the vehicle, such as by drilling holes or installing permanent brackets.

On certain vehicles having an external tire carrier or rear tire frame, such as the Jeep Wrangler®, it may be possible to affix an accessory or accessory mounting system on the external tire itself. However, traditional mounting brackets that utilize a vehicle's rear tire tend to be at least as large as the tire itself, making it difficult to transport and store such brackets when not in use. And, such devices must generally be made to fit a particular size of tire, limiting the number of vehicles with which a particular mounting bracket may be compatible.

A need therefore exists for an accessory or accessory mounting system configured to attach to the external tire of an automobile, that is collapsible for storage and adjustable for use with tires of varying sizes and models.

### SUMMARY

This disclosure is directed to collapsible tire attachments for mounting accessories to an automobile, and vehicle accessory mounting systems.

In one embodiment, a collapsible tire attachment is disclosed comprising a central bracket having an inner surface and an outer surface, a first arm having a proximal end and a distal end that is rotatably attached to the central bracket at the proximal end, and having a first tire connector at the distal end, a second arm having a proximal end and a distal end that rotatably attached to the central bracket at the proximal end, and having a second tire connector at the distal end, and a third arm having a proximal end and a distal end that is rotatably attached to the central bracket at the proximal end. The first arm, second arm and third arm may be rotatable between a deployed position and a not deployed position. When in the deployed position, the collapsible tire attachment may be attached to an automobile tire at the first tire connector and second tire connector. The length of the arms may be variable, and for example may be expanded or contracted by between 1 and 10 inches. The arms may further include a ball catch configured to releasably fix the length of the arms. And the central bracket may further include latches to secure the arms in a deployed position.

The collapsible tire attachment may further be configured to work with an accessory mount having a first leg and a second leg, wherein the first and second legs are capable of removably attaching to the first and second arms. The first and second legs of the accessory mount may also include a cross-member having a platform capable of supporting and attaching various accessories. According to some embodiments, face plates, such as those compatible with the MOLLE® system, may provide additional attachment points for accessories, ropes, cables, tie downs, or other features.

The accessory mount may further include a vehicle accessory capable of removable attachment to the platform. According to some embodiments, the accessory may be a collapsible basket, having an inner portion and an outer portion, wherein the inner portion is capable of telescoping attachment to the outer portion. The accessory may also include one or more attachment points for removable attachment to the platform. In some configurations, the accessory may include wheels, which may be removably attached to the accessory, as well as a handle, so that the accessory can be operated as a wagon when not attached to the vehicle.

This disclosure is also directed to a vehicle accessory mounting system having a vehicle accessory with an inner member and an outer member, wherein the inner member is configured for telescoping attachment to the outer member, the outer member having a first accessory mounting point and a second accessory mounting point, an accessory mount, removably attached to the first accessory mounting point and to the second accessory mounting point, wherein the accessory mount is capable of removable attachment to a vehicle tire.

According to some embodiments, the accessory mount may include a central bracket having an inner surface and an outer surface, a first arm having a proximal end and a distal end, said first arm rotatably attached to the central bracket at the proximal end, and having a first tire connector at the distal end, a second arm having a proximal end and a distal end, said second arm rotatably attached to the central bracket at the proximal end, and having a second tire connector at the distal end, wherein the first arm is configured for removable attachment to the first accessory mounting point, and wherein the second arm is configured for removable attachment to the second accessory mounting point.

This disclosure is also directed to methods of attaching a collapsible tire attachment to an automobile tire, and attaching accessories thereon. According to one embodiment this method includes the step of providing a collapsible tire attachment including a central bracket having an inner surface and an outer surface, a first arm having a proximal end and a distal end, said first arm rotatably attached to the central bracket at the proximal end and having a first tire connector at the distal end, a second arm having a proximal end and a distal end, said first arm rotatably attached to the central bracket at the proximal end and having a second tire connector at the distal end, a third arm having a proximal end and a distal end, said first arm rotatably attached to the central bracket at the proximal end, wherein the first arm, second arm and third arm are rotatable between a deployed position and a not deployed position, the step of placing the first arm, second arm and third arm in the deployed position by rotating said arms about the central bracket, the step of placing the collapsible tire attachment on an automobile tire, and the step of securing the collapsible tire attachment to the automobile tire at the first tire connector and second tire connector.

Methods consistent with this disclosure may also include the step of providing a vehicle accessory mount having a first leg with a first expandible bracket, and a second leg with a second expandible bracket, a cross-member disposed between the first leg and the second leg via the expandible bracket, and an accessory platform disposed on an upper surface of the cross-member having a plurality of removable attachment points, the step of aligning the first leg with a surface of the first arm, the step of changing the longitudinal dimension of the cross-member via the first and second expandible brackets until the second leg is aligned with a surface of the second arm, and the step of securing the first leg to the first arm, and the second leg to the second arm with mechanical fasteners.

Additional methods may also include the step of providing a vehicle accessory having an inner portion including an inner floor member inner wall member, an outer portion including an outer floor member and outer wall member and a first and second mounting point, wherein the inner floor member is capable of telescoping attachment to the outer floor member, and the inner wall member is capable of telescoping attachment to the outer wall member, the step of attaching the inner portion to the outer portion, the step of attaching the first mounting point to a first removable attachment point of the plurality of removable attachment points, and the step of attaching the second mounting point to a second removable attachment point of the plurality of removable attachment points.

### DESCRIPTION OF THE DRAWINGS

FIG. 1 is a perspective view of a vehicle accessory mounting system.

FIG. 2 is a perspective view of a tire attachment in a deployed position.

FIG. 3 is a perspective view of a tire attachment in a storage position.

FIG. 4 is an exploded perspective view of an accessory mount.

FIG. 5 is an exploded perspective view of an accessory.

FIG. 6 is a perspective view of an accessory.

FIG. 7 is a flowchart of the usage.

FIG. 8 is a flowchart of the usage.

FIG. 9 is a flowchart of the usage.

### DETAILED DESCRIPTION

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

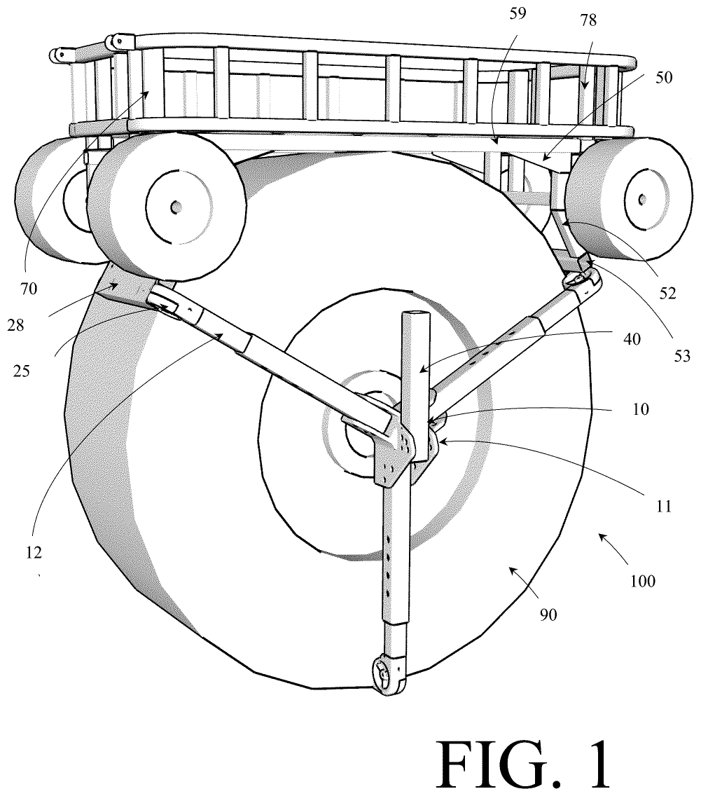

Referring to FIG. 1, a vehicle accessory mounting system 100 may include a tire attachment 10, configured for attachment to a vehicle tire 90, an accessory mount 50 and an accessory 70. Tire attachment 10 may further comprise a central bracket 11, configured to attach a plurality of arms, 12, connected to an elbow 25 that is further connected to a secondary arm 28, and a primary attachment point 40. Accessory mount 50 may comprise a plurality of mounting legs 52 configured to be removably attached to arms 12 via a plurality of feet 53, and a platform 59. Accessory 70 may include a plurality of accessory sheaths 78 configured for removable attachment to platform 59.

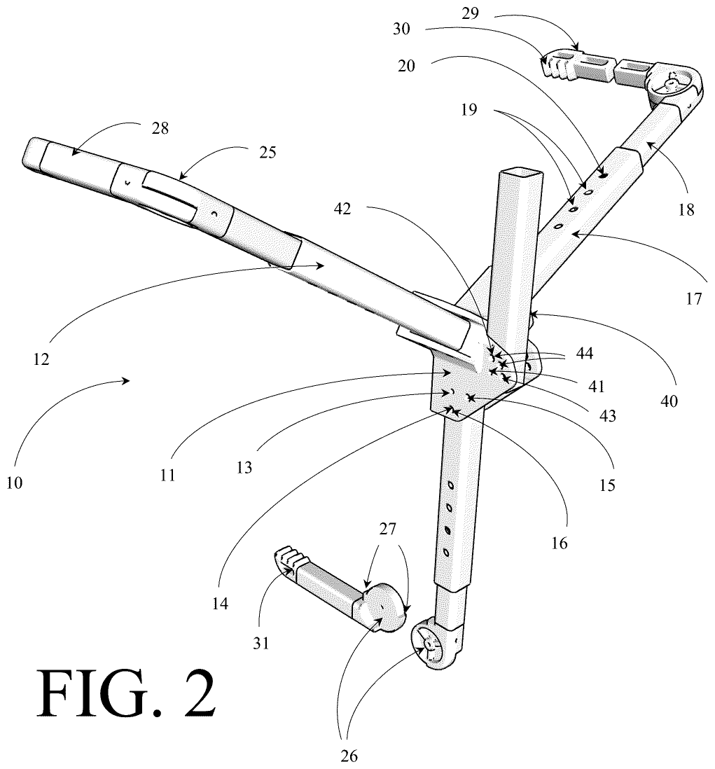

Referring to FIG. 2, central bracket 11 may be constructed of a durable material capable of withstanding significant twisting and sheer forces while also remaining weather resistant. Such materials may include galvanized steel, stainless steel, or aluminum. Central bracket 11 may be casted, machined, or constructed through additive manufacturing. According to one embodiment, central bracket 11 is configured to attach three arms 12, evenly spaced approximately 120° from one another. According to another embodiment, central bracket 11 may be configured to attach four arms 12, spaced approximately 90° from one another. Central bracket 11 may be configured to attach as few as two arms 12, or more than four arms 12, without departing from the spirit of this disclosure.

Each arm 12 is attached at its proximal end to central bracket 11 via a hinge 13. In some embodiments, hinge 13 may be a spring-loaded hinge configured maintain arm 12 in a storage position, in which each arm 12 is rotated into proximity to one another, unless acted upon by an external force. In other embodiments, hinge 13 may be a spring-loaded hinge configured to maintain arm 12 in a deployed position, in which each arm 12 is extended radially away from one another, unless acted upon by an external force. In still other embodiments, hinge 13 is not spring loaded, and arm 12 may be permitted to move freely between a deployed position and a storage position, unless fixed using a mechanical fastener.

For each arm 12, central bracket 11 may also include a deployed locking point 14 and a storage locking point 15. According to some embodiments, deployed locking point 14 and storage locking point 15 are configured to align with a corresponding locking mechanism 16 on arm 12 when said arm 12 is in a deployed position or a storage position, respectively. According to one embodiment, deployed locking point 14, storage locking point 15 and corresponding locking mechanism 16 are in the form of holes sized to accommodate a pin or bar. When arm 12 is in the deployed position, said pin may be inserted through deployed locking point 14 and corresponding locking point 16, preventing arm 12 from rotating about hinge 13 and thereby locking arm 12 in the deployed position. When arm 12 is in the storage position, said pin may be inserted through storage locking point and corresponding locking mechanism 16, locking arm 12 in the storage position.

Other methods of affixing arm 12 in the storage position or locked position may be used without departing from the spirt of this disclosure. For example, corresponding locking mechanism 16 may be in the form of a spring-loaded ball catch, and deployed locking point 14 and storage locking point 15 may be holes sized to accommodate said ball catch. In this configuration, the ball catch of corresponding locking mechanism 16 may be depressed to rotate arm 12 from the storage position to deployed position, or vice versa. When the ball catch of corresponding locking mechanism 16 aligns with the hole of either deployed locking mechanism 14 or storage locking mechanism 15, spring force causes the ball catch to protrude through said locking point, securing arm 12 in a fixed position.

Arm 12 may be a telescoping arm constructed of a sleeve 17, having a hollow interior such that an inner member 18 may be slidably inserted therein. Sleeve 17 may further comprise perforations 19 spaced at regular intervals along the length of sleeve 17. Perforations 19 are configured to align with a telescoping latch 20 disposed on inner member 18. According to one embodiment, telescoping latch 20 is a spring-loaded ball catch. Spring force may cause the ball catch of telescoping latch 20 to protrude through one perforation 19, preventing inner member from moving relative to the length of sleeve 18. When the ball catch of telescoping latch 20 is manually depressed, the length of arm 12 may be increased or decreased by moving inner member 18 relative to sleeve 17, until telescoping latch 20 aligns with another perforation 19. Alternatively, telescoping latch 20 may be in the form of a pin or pole extending through perforation 19 and telescoping latch 20, preventing lateral motion of inner member 18 relative to sleeve 17.

Inner member 18 and sleeve 17 may be constructed of a durable and weather resistant material, such as aluminum, galvanized steel, stainless steel carbon fiber or fiberglass. According to one embodiment, inner member 18 and sleeve 17 may be constructed of square tube stock aluminum. According to another embodiment, inner member 18 and sleeve 18 may be constructed of round tube stock. In other embodiments, inner member 18 may be constructed of solid material.

When fully extended by sliding inner member 18 until telescoping latch 20 aligns with the most distal perforation 19 of sleeve 17, arm 12 may be lengthened to accommodate a tire of any size found in conventional consumer automobiles. For example, on vehicles that can accommodate tires of 30 to 40 inches in diameter, arm 12 may be extensible to at least the radius of said tire, or from about 15 to 20 inches.

According to other embodiments, arm 12 may have a fixed length corresponding to a specific radius of tire.

An elbow, 25 may be attached at its proximal end to each of the distal ends of arms 12. According to some embodiments, elbow 25 may be comprised of two circular members 26 that may be rotatably coupled to one another, such as by a pin or bar. Circular member 26 may be constructed with stops 27 that allow elbow 25 to rotate 90° between a deployed position and a storage position, but that prevent elbow 25 from over rotating. According to some embodiments, elbow 25 may be comprised of two circular members 26 rotatably attached 180° from one another, thus reducing the number of distinct parts that are required for construction. Circular members 26 may be constructed of cast material, including ABS plastic, aluminum, or steel, or may be a machined part. According to other embodiments, elbow 25 may alternatively be constructed of a pinned hinge, an L-bracket, or other method of attachment known in the art without departing from the spirit of this disclosure.

A secondary arm 28 may be connected at its proximal end to each of the distal ends of elbows 25. In its deployed position, secondary arm 28 may be configured to contact the exterior surface of a vehicle tire 90 on its outer tread surface via a tire connector 29. Tire connector 29 may comprise a gripping portion 30, configured to make a high-friction contact with the tire surface, as well as a loop 31 configured to allow a high tensile strength strap, cable, band or hook to be passed through. According to one embodiment, a strap, cable or band may be passed through each of the plurality of loops and tightened about the circumference of vehicle tire 90. According to other embodiments, the high tensile cable, strap, or band that can be secured to the body of an automobile tire, to another loop 31 disposed on a separate arm, or a suitable location on the vehicle's tire, frame or chassis.

Primary attachment point 40 may be located on the exterior surface of central bracket 11, and connected to central bracket 11 via primary attachment point hinge 41. In one embodiment, primary attachment point 40 is configured to support a flagpole and flag, such as the American flag, or other sort of banner or symbol that a vehicle owner may wish to display as a show of patriotism or belief. However, primary attachment point 40 may alternatively support a variety of attachments including poles, hooks, baskets, or other accessories, without departing from the spirit of this disclosure. Primary attachment point 40 may be configured to be placed in a storage position, in which primary attachment point 40 extends perpendicular to the exterior surface of central bracket 11, and is secured at storage point 43 via primary attachment point locking mechanism 42. According to some embodiments, primary attachment point locking mechanism 42 may be a ball catch configured to align with a hole or slot at storage point 43. Alternatively, primary attachment point locking mechanism 42 may be a pin or bar. Additional locking mechanisms may be used to secure primary attachment point 40 in a fixed position without departing from the spirit of this disclosure.

Central bracket 11 may also include one or more deployment points 44 in the form of a hole or slot configured to align with primary attachment point locking mechanism 42, for when primary attachment point 40 is to be placed in a deployed position. According to one embodiment, central bracket 11 includes two deployment points, configured to lock primary attachment point 40 in a position at 45° relative to the vertical position of primary attachment point 40 in the storage position, or 90° relative to the vertical position of primary attachment point 40 in the storage position. In use, this would allow a flag, pole, banner, or other accessory device to be mounted to tire attachment 10 in either a vertical position, or in an inclined position projecting at an angle away from the rear of the vehicle. In other embodiments, central bracket 11 may include one deployment point 44 at any angle between 0 and 90° relative to the vertical position of primary attachment point 40 in the storage position, or more than two deployment points 44 at any such angles. Alternatively, central bracket 11 can be configured with deployment points 44 allowing for a full 180° range of motion. For example, central bracket may include 5 deployment points 44, at 0° relative to the vertical position of tire mount accessory 40, 45°, 90°, 135° and 180°. Primary attachment point 40 may also be constructed of a durable and weather resistant material, such as aluminum, galvanized steel, stainless steel carbon fiber or fiberglass. In one embodiment, primary attachment point 40 is constructed of square tube stock aluminum. According to another embodiment, primary attachment point 40 is constructed of round tube steel.

Tire attachment 10 may also be used apart from a vehicle tire. With arms 12 extended in the deployed position, tire attachment 10 can be placed on the ground as a vertical stand, or according to some embodiments, a tripod. Primary attachment point 40 may then be fixed in the 90° angle, allowing attachments to be mounted vertically on the stand. Such attachments could include a flag, a pole, light, a portable loudspeaker, a camera, or other such devices.

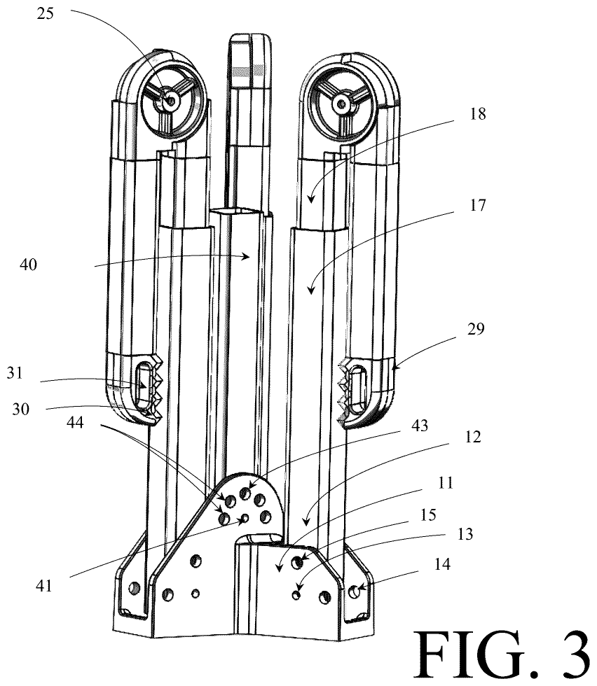

Referring to FIG. 3, tire attachment 10 may be placed in a storage configuration when not in use. In this configuration, secondary arms 28 are rotated about elbow 25 until they are substantially parallel to arm 12. Inner member 18 is fully inserted into sleeve 17 until it is fully compacted, and arm 12 is rotated about hinge 13 until each arm 12 is substantially parallel to one another. Primary attachment point 40 is rotated about primary attachment point hinge 41 until it too is substantially parallel to arms 12. This configuration allows for easy storage in a vehicle or a container, without taking up unnecessary cargo space.

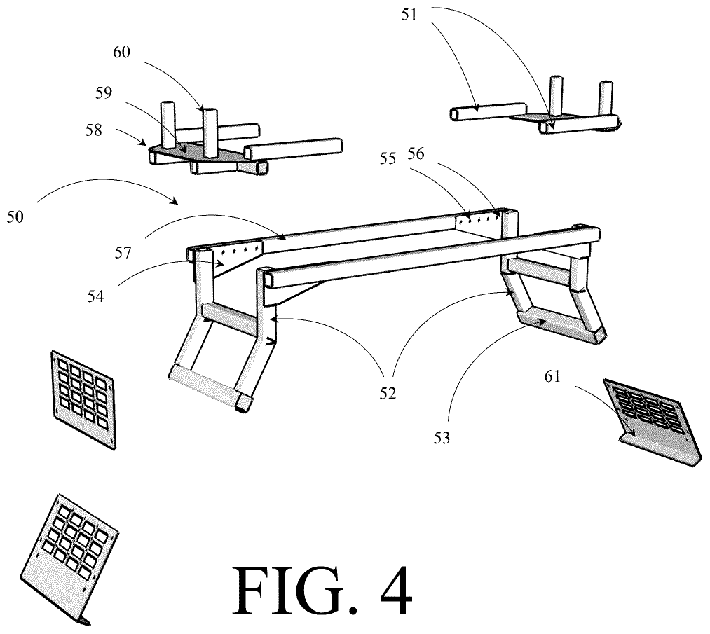

Referring to FIG. 4, an accessory mount 50 comprises mounting legs 52 disposed at a fixed angle, terminating at their distal end in a plurality of feet 53 configured to make surface contact with an outer surface of secondary arm 28. Because arms 12 of tire attachment 10 project away from central bracket 11 at fixed angles, mounting legs 52 may likewise be disposed at fixed angles to ensure surface-to-surface contact between mounting legs 52 and secondary arms 28. For example, in an embodiment comprising three arms positioned at 120° from one another, feet 53 and mounting legs 52 may be angled at 15° relative to vertical. According to one embodiment, mounting legs 52 have an angled portion, angled at 15° relative to vertical, which transitions into a vertical portion. However, other embodiments may comprise no vertical portion.

Feet 53 may be affixed to arms 12 in a variety of ways, including clamps, straps, bolts or pins. According to one embodiment, feet 53 may be attached to arms 12 using a plurality of mechanical fasteners, such as machine screws, to provide a rigid attachment point between feet 53 and arms 12.

According to one embodiment, mounting legs 52 terminate at their proximal end at an expandible bracket 54, having a plurality of mounting holes 55. Mounting holes 55 are configured to align with corresponding holes 56 located on a plurality of cross-members 57. Said mounting holes 55 and corresponding holes 56 are configured to be joined in any manner known in the art, including bolts, machine screws, ball catches, pins or bars. The plurality of mounting holes 55 and corresponding holes 56 permit accessory mount 50 to be horizontally expanded or contracted in order to be mounted on tires of various sizes. For example, cross-member 57 may be extensible up to several inches to accommodate tires up to 40 inches in diameter. Mounting legs 52, feet 53 and expandible bracket 54 may be constructed of any material capable of supporting significant weight and shear forces when used as a vehicle accessory, including tube steel, tube aluminum, galvanized steel, and various polymers known in the art.

According to one embodiment, cross-members 57 are constructed of square tube steel, having open exterior ends with an inner diameter capable of accommodating a plurality accessory connectors 58. Each accessory connector 58 may comprise an inner member configured to be slidably inserted into the open end of cross member 57 as well as a platform 59 configured to support a plurality of vertical connectors 60. Vertical connectors 60 may be constructed of solid material, such as steel or aluminum, and may be configured to be slidably inserted into a corresponding accessory sheath 78 on accessory 70. According to one embodiment, a pair of accessory connectors 58 may be configured to be affixed to each of the longitudinal ends of cross members 57. And, each accessory connector 58 may be configured to have a pair of vertical connectors 60. Accessory connector 58 may also be removed when no accessory 70 is attached, reducing the profile of vehicle accessory mounting system 100.

According to one embodiment, mounting legs 52 and feet 53 may provide a plurality of exterior surfaces for the attachment of additional face plates 61, such as MOLLE-style panels, or similar connectors and attachment points for additional straps or accessories.

Additionally, accessory mount 50 may be used apart from a vehicle tire. When placed on the ground, accessory mount 50 may be used as a stool, a small table to keep items off the ground, or as a platform for accessories as described herein.

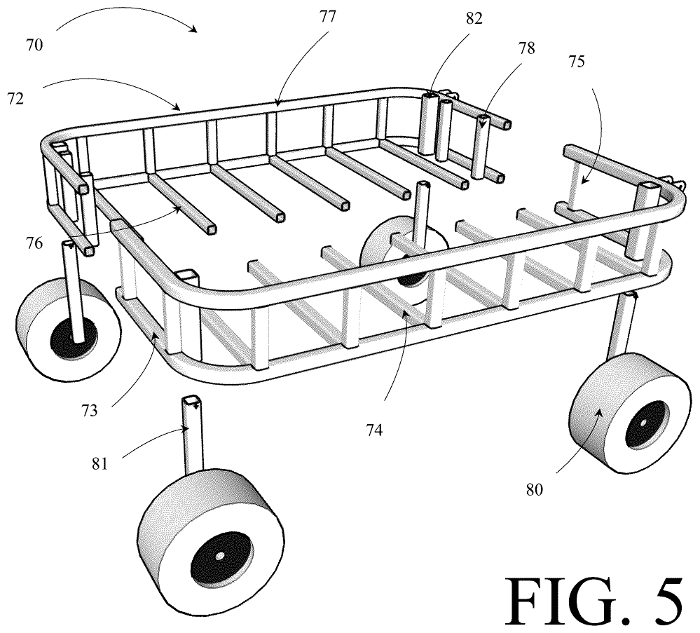

Referring to FIG. 5, an accessory 70 may take the form of a collapsible basket. According to one embodiment, accessory 70 comprises an outer basket portion 72 and an inner basket portion 73, wherein the inner basket portion 73 may be comprised of a plurality of rigid floor members 74 and wall members 75. Said floor members 74 and wall members 75 may be configured to be slidably inserted into corresponding floor members 76 and corresponding wall members 77 of the outer basket portion 72. As such, outer basket portion 72 may be constructed of any hollow material capable of supporting significant weight in the context of an automotive accessory, such as hollow tube steel or hollow tube aluminum. Inner basket portion 73 may similarly be constructed of hollow material, such as hollow tube steel or hollow aluminum steel, provided that the outer diameter of the material used to construct the inner basket portion 73 is narrower than the inner diameter of the outer basket portion 72. Alternatively, inner basket portion 73 may be constructed of solid material. According to one embodiment, when the inner basket portion 73 is slidably inserted fully into outer basket portion 72 accessory 70 may be only slightly wider than accessory mount 50, and capable of being secured on vehicle tire 90 without extending unnecessarily behind the vehicle. For one such embodiment, accessory 70 is 17 inches wide in its collapsed state, and extensible to 23 inches in its deployed state.

Accessory 70 may also comprise a plurality accessory sheaths 78 configured to slidably attach to vertical connectors 60. According to one embodiment, a pair of accessory sheaths 78 are attached to the outer basket portion 72. During transit, each of the outer basket portion 72 and inner basket portion 73, as well as the accessory sheaths 78 and vertical connectors 60, and accessory connector 58 and cross member 57, may be mechanically fastened to one another, such as by a ball catch or spring-pins.

According to another embodiment, a pair of accessory sheaths 78 may be permanently affixed to each of the outer basket portion 72 and inner basket portion 73. In such a configuration, because accessory connector 58 is capable of expanding longitudinally, but not by width, and because accessory sheaths 78 are configured to expand by width but not longitudinally, accessory 70 may be affixed to accessory mount 50 without additional mechanical fastening, while remaining rigidly attached to tire attachment 10.

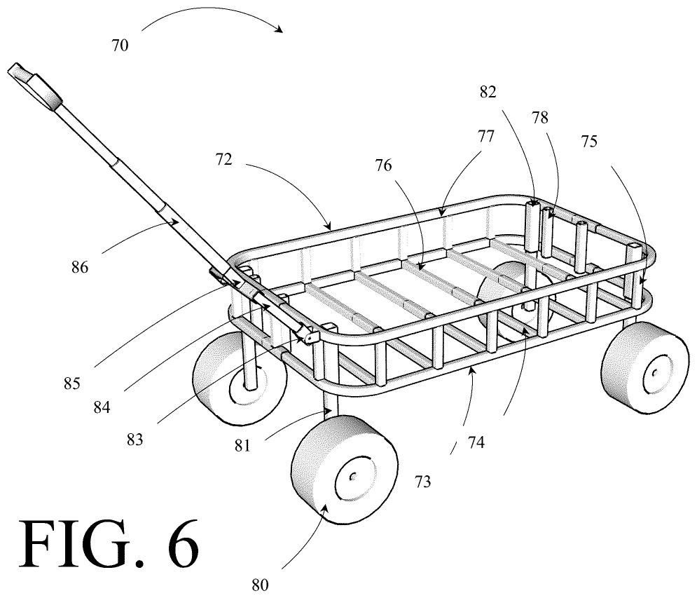

Referring to FIG. 6, another embodiment of accessory 70 may also comprise a plurality of wheels 80, each having a wheel connector 81 attached perpendicular to the wheel 80 via an axle, which are capable of slidable attachment a plurality of wheel sheaths 82 disposed parallel to accessory sheaths 78. Such wheel sheaths may include a plurality of mechanical stops that allow a plurality of wheel connectors 81 to be either fully inserted, inserted in a low-profile storage position, or inserted in an extended position for use as a wagon. The addition of wheel sheaths allows accessory 70 to be affixed to vehicle accessory mounting system 100 without removing and separately storing wheels 80. This configuration also allows accessory 70 to act as a large capacity wagon, capable of holding and transporting large items such as luggage or coolers.

Additionally, another embodiment of accessory 70 may also comprise a bi-directional bracket 83 affixed at one end to each of outer basket portion 72 and inner basket portion 73. Each bi-direction bracket may be configured to attach at its opposite end to the proximal end of a connecting rod 84, which may be attached to handle bracket 85. Handle bracket 85 may be connected to a wagon handle 86, which may be comprised of telescoping rods configured to be collapsed or extended. The use of bi-directional brackets 83 and handle bracket 85, allow accessory 70 to be collapsed or expanded without removing the wagon handle 86 from accessory 70.

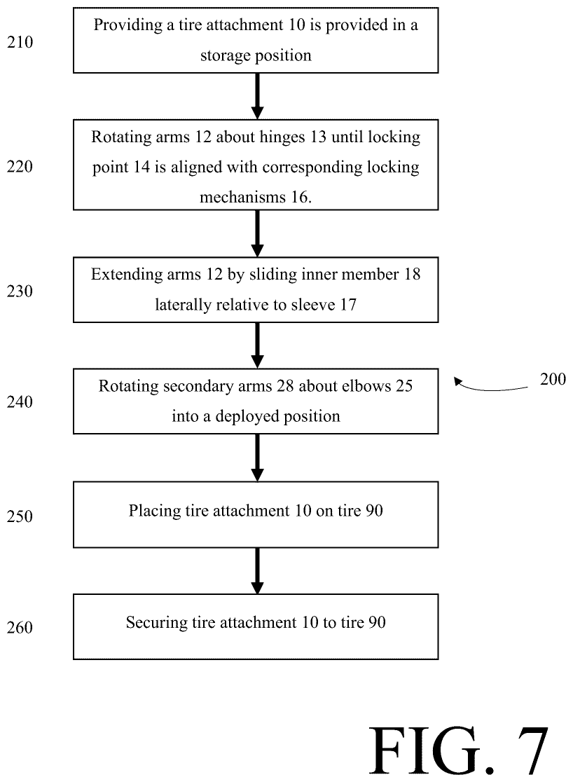

Referring to FIG. 7, a method 200 of attaching a tire attachment 10 to a vehicle tire 90 is described. In step 210 a tire attachment 10 is provided in a storage position. In step 220, arms 12 are rotated about hinges 13 until corresponding locking mechanism 16 on arms 12 aligns with deployed locking point 14. In step 230, arm 12 is extended by sliding inner member 18 laterally relative to sleeve 17 until telescoping latch 20 aligns with a perforation 19. In step 240, secondary arms 28 are rotated about elbows 25 into a deployed position. In step 250 tire attachment 10 is placed on the vehicle tire 90. In step 260, tire attachment 10 is secured to vehicle tire 90 via gripping portions 30 and loops 31.

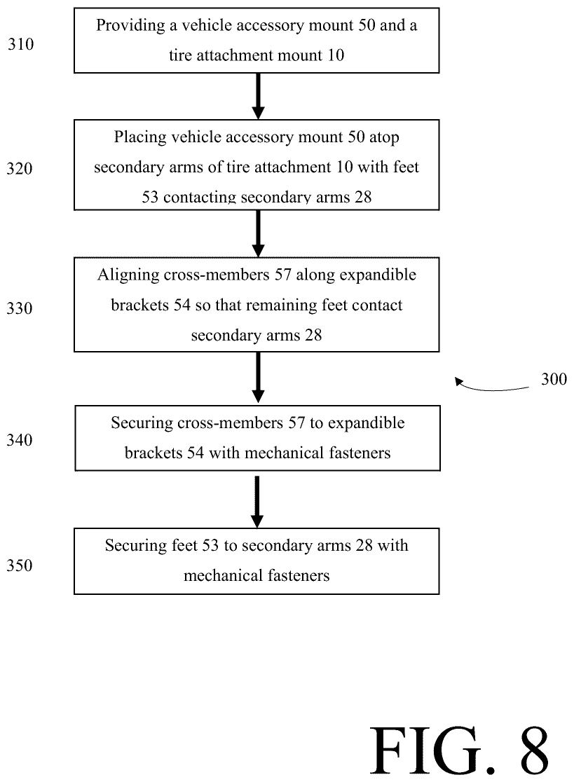

Referring to FIG. 8 a method 300 of attaching a vehicle accessory mount 50 to a tire attachment 10 is described. In step 310, a vehicle accessory mount 50 having a plurality mounting legs 52, with a plurality of expandible brackets 54 at one end of each of the mounting legs 52 connected to a plurality of cross-members 57, and terminating at the other end of the mounting legs 52 at a plurality of feet 53 is provided, along with a tire attachment mount 10 having secondary arms 28. In step 320, vehicle accessory mount 50 is placed atop the secondary arms 28 of tire attachment 10, such that at least one of the feet 53 contact the surface of secondary arms 28. In step 330, a plurality of cross-members 57 are moved longitudinally along expandible brackets 54 until at least one additional plurality of feet 53 contact the surface of at least one additional secondary arm 28, and the mounting holes 55 in the plurality of expandible brackets 54 align with the corresponding holes 56 of the plurality of cross-members 57. In step 340, the plurality of cross-members 57 are secured to the plurality of expandible brackets 54 using mechanical fasteners connecting the mounting holes 55 to the corresponding mounting holes 56. In step 350, the plurality of feet 53 are secured to the plurality of secondary arms 28 via mechanical fasteners.

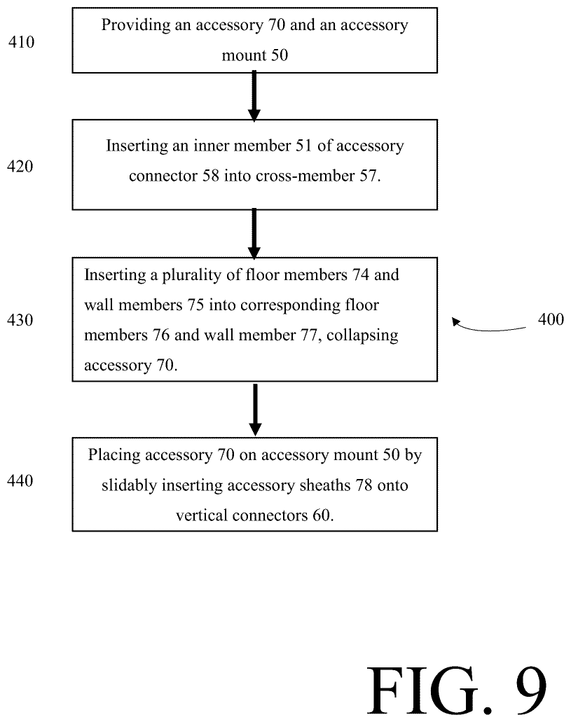

Referring to FIG. 9, a method 400 of attaching an accessory 70 to a vehicle accessory mount 50 is described. In step 410, an accessory 70 having a plurality of floor members 74 and wall members 75 of an inner basket portion 73 and a plurality of corresponding floor members 76 and corresponding wall members 77 of outer basket portion 72, and a plurality of accessory sheaths disposed vertically on each of the inner basket portion 73 and outer basket portion 72, along with an accessory mount having a plurality of accessory connectors 58 each comprising a platform, a plurality of inner members 51 and a plurality of vertical connectors are provided. In step 420, an inner member 51 of accessory connector 58 is inserted into each longitudinal end of each cross-member 57. In step 430, the plurality of floor members 74 and wall members 75 of an inner basket portion 73 are slidably inserted into the corresponding floor members 76 and corresponding wall member 77 of outer basket portion 72, until accessory 70 is fully collapsed. In step 440, accessory 70 is placed on vehicle accessory mount 50 by slidably inserting the plurality accessory sheaths 78 of accessory 70 onto a plurality of vertical connectors 60 disposed on a plurality of platforms 59 of accessory connectors 58.

Having now described some illustrative embodiments, it is apparent that the foregoing is illustrative and not limiting, having been presented by way of example. In particular, although many of the examples presented herein involve specific combinations of elements, those elements may be combined in other combinations. Elements and features discussed only in connection with one embodiment are not intended to be excluded from other embodiments.

Any references to front and back, left and right, top and bottom, or upper and lower and the like are intended for convenience of description, not to limit the present systems and methods or their components to any one positional or spatial orientation.

Any references to embodiments or elements herein referred to in the singular may also embrace embodiments including a plurality of these elements, and any references in plural to any embodiment or element herein may also embrace embodiments including only a single element. References in the singular or plural form are not intended to limit the presently disclosed components or elements to single or plural configurations.

Any embodiment disclosed herein may be combined with any other embodiment, and references to “an embodiment,” “some embodiments,” “an alternate embodiment,” “various embodiments,” “one embodiment” or the like are not necessarily mutually exclusive and are intended to indicate that a particular feature or characteristic described in connection with the embodiment may be included in at least one embodiment. Such terms as used herein are not necessarily all referring to the same embodiment. Any embodiment may be combined with any other embodiment, inclusively or exclusively, in any manner consistent with the aspects and embodiments disclosed herein.

What is claimed is:

1. A collapsible tire attachment comprising:
a central bracket having an inner surface and an outer surface,
a first arm having a proximal end and a distal end, said first arm rotatably attached to the central bracket at the proximal end, and having a first tire connector at the distal end;
a second arm having a proximal end and a distal end, said first arm rotatably attached to the central bracket at the proximal end, and having a second tire connector at the distal end;
a third arm having a proximal end and a distal end, said first arm rotatably attached to the central bracket at the proximal end;
a primary attachment point disposed on the outer surface of the central bracket;
wherein the first arm, second arm and third arm are rotatable between a deployed position and a not deployed position; and
wherein in the deployed position, the collapsible tire attachment may be attached to an automobile tire at the first tire connector and second tire connector.

2. The collapsible tire attachment of claim 1, wherein the lengths of the first arm, second arm and third arm are extensible by between 1 and 10 inches.

3. The collapsible tire attachment of claim 1, wherein the first arm further includes a ball catch.

4. The collapsible tire attachment of claim 1, wherein the central bracket further includes a latch configured to releasably secure the first arm in the deployed position.

5. The collapsible tire attachment of claim 1, further comprising:
an accessory mount having a first leg and a second leg, wherein the first leg is capable of removably attaching to the first arm, and the second leg is capable of removably attaching to the second arm;
a cross-member disposed between the first leg and second leg; and
a platform connected to the cross-member.

6. The collapsible tire attachment of claim 5, further comprising a face panel connected to the first leg, wherein the face panel includes attachment points.

7. The collapsible tire attachment of claim 6, wherein the face panel is a MOLLE® panel.

8. The collapsible tire attachment of claim 5, further comprising: an accessory removably attached to the platform.

9. The collapsible tire attachment of claim 8, wherein the accessory comprises an inner portion having an inner floor member and an inner wall member, and an outer portion having an outer floor member and an outer wall member, wherein the inner portion is capable of telescoping attachment to the outer member.

10. The collapsible tire attachment of claim 9, wherein the inner portion further comprises a first attachment point, and the outer portion further comprises a second attachment point, wherein the accessory is removably attached to the platform via the first attachment point and second attachment point.

11. The collapsible tire attachment of claim 8, wherein the accessory comprises a plurality of wheels.

12. The collapsible tire attachment of claim 11, wherein the accessory further comprises a handle.

13. A vehicle accessory mounting system, comprising:
a vehicle accessory having an inner member and an outer member, wherein the inner member is configured for telescoping attachment to the outer member;
a first accessory mounting point attached to the inner member, and a second accessory mounting point attached to the outer member; and
an accessory mount, removably attached to the first accessory mounting point and to the second accessory mounting point,
wherein the accessory mount is capable of removable attachment to a vehicle tire.

14. The vehicle accessory mounting system of claim 13, wherein the accessory mount comprises:
a central bracket having an inner surface and an outer surface,
a first arm having a proximal end and a distal end, said first arm rotatably attached to the central bracket at the proximal end, and having a first tire connector at the distal end;
a second arm having a proximal end and a distal end, said second arm rotatably attached to the central bracket at the proximal end, and having a second tire connector at the distal end;
wherein the first arm is configured for removable attachment to the first accessory mounting point; and
wherein the second arm is configured for removable attachment to the second accessory mounting point.

15. A method of attaching a collapsible tire attachment to an automobile tire comprising;
providing a collapsible tire attachment including a central bracket having an inner surface and an outer surface, a first arm having a proximal end and a distal end, said first arm rotatably attached to the central bracket at the proximal end and having a first tire connector at the distal end; a second arm having a proximal end and a distal end, said second telescoping arm rotatably attached to the central bracket at the proximal end and having a second tire connector at the distal end; a third arm having a proximal end and a distal end, said third arm rotatably attached to the central bracket at the proximal end; wherein the first arm, second arm and third arm are rotatable between a deployed position and a not deployed position;
placing the first arm, second arm and third arm in the deployed position by rotating said arms about the central bracket;
placing the collapsible tire attachment on an automobile tire; and
securing the collapsible tire attachment to the automobile tire at the first tire connector and second tire connector.

16. The method of claim 15, further comprising:
providing a vehicle accessory mount having a first leg with a first expandible bracket, and a second leg with a second expandible bracket, with a cross-member disposed between the first leg and the second leg via the expandible bracket, and an accessory platform disposed on an upper surface of the cross-member having a plurality of removable attachment points;
aligning the first leg with a surface of the first arm;
changing the longitudinal dimension of the cross-member via the first and second expandible brackets until the second leg is aligned with a surface of the second arm; and
securing the first leg to the first arm, and the second leg to the second arm with mechanical fasteners.

17. The method of claim 16, further comprising:
providing a vehicle accessory having an inner portion including an inner floor member inner wall member, an outer portion including an outer floor member and outer wall member and a first and second mounting point, wherein the inner floor member is capable of telescoping attachment to the outer floor member, and the inner wall member is capable of telescoping attachment to the outer wall member,
attaching the inner portion to the outer portion;
attaching the first mounting point to a first removable attachment point of the plurality of removable attachment points;
attaching the second mounting point to a second removable attachment point of the plurality of removable attachment points.
